(19) United States
(12) Patent Application Publication
(10) Pub. No.: US 2026/0323448 A1
(43) Pub. Date: Oct. 15, 2026

(54) TECHNIQUES TO TRANSFER INFORMATION IN AN INTEGRATED ACCESS AND BACKHAUL SYSTEM

(71) Applicant: ZTE CORPORATION, Shenzhen, Guangdong (CN)

(72) Inventors: Ying HUANG, Shenzhen (CN); Lin CHEN, Shenzhen (CN)

(21) Appl. No.: 19/104,482

(22) PCT Filed: Nov. 4, 2022
(86) PCT No.: PCT/CN2022/129971

§ 371 Date: Feb. 18, 2025

(51) Int. Cl. H04W 36/08; H04W 36/00; H04W 88/08

(52) U.S. Cl. CPC H04W 36/087; H04W 36/0064; H04W 36/0077; H04W 88/085

(57) ABSTRACT

Techniques are described for transferring information in an integrated access and backhaul system. An example wireless communication method includes receiving, by a first network device, a migration type information that indicates a type of handover associated with a handover operation of a mobile network device from the first network device to a second network device, where the first network device receives the migration type information from a third network device.

### TECHNICAL FIELD

This document is directed generally to digital wireless communications.

### BACKGROUND

Mobile telecommunication technologies are moving the world toward an increasingly connected and networked society. In comparison with the existing wireless networks, next generation systems and wireless communication techniques will need to support a much wider range of use-case characteristics and provide a more complex and sophisticated range of access requirements and flexibilities.

Long-Term Evolution (LTE) is a standard for wireless communication for mobile devices and data terminals developed by 3rd Generation Partnership Project (3GPP). LTE Advanced (LTE-A) is a wireless communication standard that enhances the LTE standard.

The 5th generation of wireless system, known as 5G, advances the LTE and LTE-A wireless standards and is committed to supporting higher data-rates, large number of connections, ultra-low latency, high reliability and other emerging business needs.

### SUMMARY

Techniques are disclosed for transferring information in an integrated access and backhaul system.

A first example wireless communication method includes receiving, by a first network device, a migration type information that indicates a type of handover associated with a handover operation of a mobile network device from the first network device to a second network device, where the first network device receives the migration type information from a third network device. In some embodiments, the method further comprises sending a first message comprising the migration type information to the second network device. In some embodiments, the method further comprises receiving a second message comprising the migration type information from the second network device; and transmitting, by the first network device and in response to the receiving the second message, the migration type information to the mobile network device.

In some embodiments, the type of handover indicates a sequence of operations associated with the handover operation for the mobile network device and/or a communication device in communication with the mobile network device. In some embodiments, the migration type information includes any one or more of: a partial migration, a full migration, a user equipment (UE) migration first that indicates that the handover operation is performed for the communication device before the handover operation for the mobile network device, a mobile termination (MT) migration first that indicates that the handover operation is first performed for the MT in the mobile network device, a distributed unit (DU) migration first that indicates that the handover operation is first performed for the DU in the mobile network device, a DU migration is executed after MT migration that indicates that the handover operation is performed for the DU in the mobile network device after the handover operation is performed for the MT in the mobile network device, a UE migration is executed after MT migration that indicates that the handover operation is performed for the communication device after the handover operation is performed for the MT in the mobile network device, a DU migration is executed before MT migration that indicates that the handover operation is performed for the DU in the mobile network device before the handover operation is performed for the MT in the mobile network device, or a UE migration is executed before MT migration that indicates that the handover operation is performed for the communication device before the handover operation is performed for the MT in the mobile network device.

In some embodiments, the first network device includes a first Integrated Access and Backhaul (IAB) donor to which the mobile network device is connected before the handover, where the second network device includes a second IAB donor to which the mobile network device will be connected after the handover, and/or where the third network device includes a third IAB donor that has a connection with the mobile network device. In some embodiments, the mobile network device includes a mobile Integrated Access and Backhaul (IAB) device.

A second example wireless communication method includes transmitting, by a second logical distributed unit (DU) in a mobile network device, information related to a communication device during a handover of the communication device from a first network device to a second network device, where the second logical DU in the mobile network device transmits the information related to the UE to the second network device, where the communication device is in communication with the mobile network device, where the second logical DU is configured to communicate with the second network device, and where the information related to the communication device includes any one or more of: a cell radio network temporary identifier (C-RNTI) allocated by the mobile network device for the communication device, a first C-RNTI allocated by a first logical DU in the mobile network device for the communication device, a second C-RNTI allocated by the second logical DU in the mobile network device for the communication device. In some embodiments, the first network device includes a source base station, and the second network device includes a target base station. In some embodiments, the mobile network device includes an Integrated Access and Backhaul (IAB) device.

A third example wireless communication method includes receiving, by a first network device from a mobile network device, an address associated with the mobile network device; and transmitting the address to a second network device. In some embodiments, the address includes a downlink (DL) transport network layer (TNL) address for F1 traffic which goes through a donor DU which connects to the second network device. In some embodiments, the first network device includes a target base station to which a mobile termination (MT) in the mobile network device is handed over, and the second network device includes a source base station from which the MT in the mobile network device is handed over. In some embodiments, the mobile network device includes an Integrated Access and Backhaul (IAB) device.

In yet another exemplary aspect, the above-described methods are embodied in the form of processor-executable code and stored in a non-transitory computer-readable storage medium. The code included in the computer readable storage medium when executed by a processor, causes the processor to implement the methods described in this patent document.

In yet another exemplary embodiment, a device that is configured or operable to perform the above-described methods is disclosed.

The above and other aspects and their implementations are described in greater detail in the drawings, the descriptions, and the claims.

### BRIEF DESCRIPTION OF THE DRAWING

FIG. 1 shows an example scenario where a mobile Integrated Access and Backhaul (IAB) node is included on or in a train.

FIGS. 2A-2B show example architectures for IAB systems.

FIG. 3 shows parent-node and child-node relationship for an IAB-node.

FIGS. 4A-4C show example scenarios of the inter-donor mobility of the mobile IAB node.

FIG. 5 shows an exemplary block diagram of a hardware platform that may be a part of a network device or a communication device.

FIG. 6 shows an example of wireless communication including a base station (BS) and user equipment (UE) based on some implementations of the disclosed technology.

FIG. 7 shows an exemplary flowchart for receiving a migration type information.

FIG. 8 shows an exemplary flowchart for transmitting information related to a communication device.

FIG. 9 shows an exemplary flowchart for receiving an address associated with a mobile network device.

### DETAILED DESCRIPTION

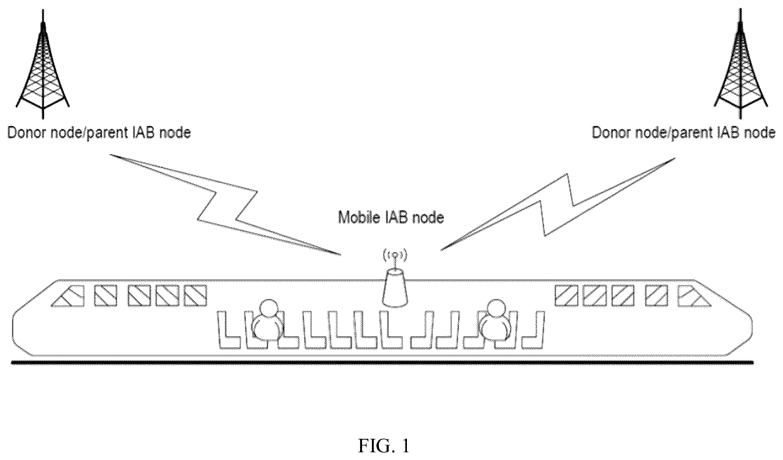

Integrated Access and Backhaul (IAB) can support wireless backhauling via new radio (NR) enabling flexible and very dense deployment of NR cells while reducing the need for wireline transport infrastructure. Intra-donor centralized unit (CU) migration procedure includes a scenario where both the source and the target parent node are served by the same IAB-donor-CU. In an Intra-donor migration (also known as handover), an IAB donor CU may not be changed. An inter-donor CU migration includes a scenario where a migrating IAB node is static. In an inter-donor migration, the IAB Donor CU is changed at least because an IAB mobile termination (MT) may have moved out of a coverage of a source donor CU or the radio link quality deteriorates so that the IAB MT may need to be served by a target donor CU. In mobile IAB use case, IAB nodes can be mounted in vehicles and can provide wireless (e.g., 5G) coverage/capacity enhancement to onboard and/or surrounding UEs such as in shown in FIG. 1 where a mobile IAB node is included on or in a train. However, current technology does not have adequate solutions for inter-donor migration in mobile IAB use case.

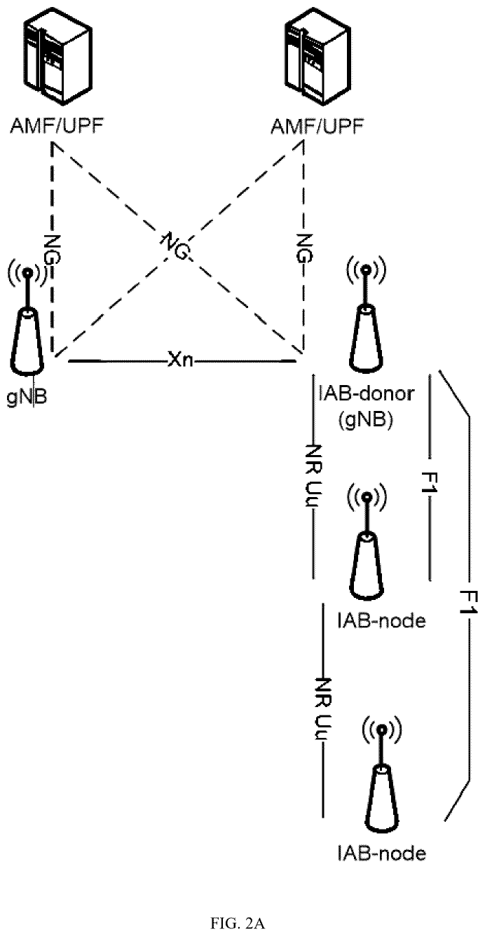

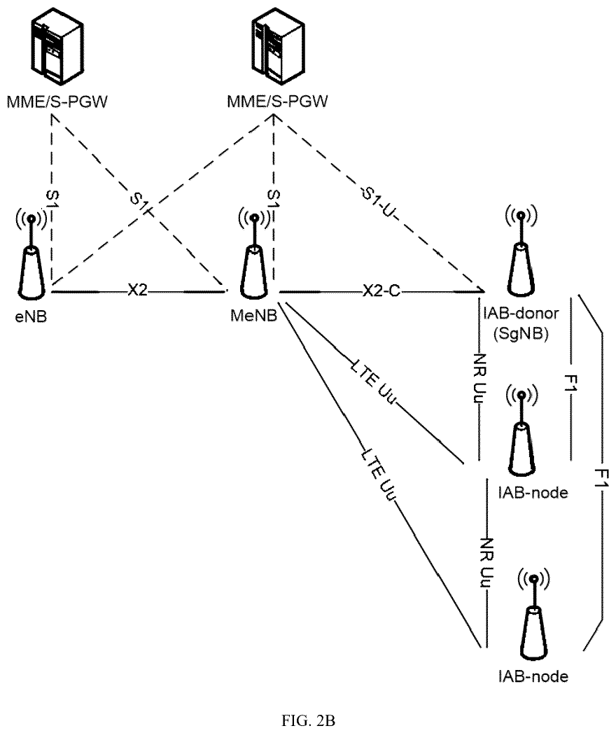

IAB can enable wireless relaying in NG-RAN. The relaying node, which can be referred to as IAB-node, can support access and backhauling via NR. The terminating node of NR backhauling on network side can be referred to as the IAB-donor, which can represent a gNB with additional functionality to support IAB. Backhauling can occur via a single or via multiple hops. The IAB architecture is shown in FIGS. 2A and 2B. FIG. 2A shows IAB-node using standalone (SA) mode with next generation core network (NGC). FIG. 2B shows IAB-node using E-UTRA-NR Dual Connectivity (EN-DC).

The IAB-node can support gNB-DU functionality, to terminate the NR access interface to UEs and next-hop IAB-nodes, and to terminate the F1 protocol to the gNB-CU functionality, on the IAB-donor. The gNB-DU functionality on the IAB-node can also be referred to as IAB-DU. DU is an acronym for distributed unit.

In addition to the gNB-DU functionality, the IAB-node can also support a subset of the UE functionality referred to as IAB-MT, which includes, e.g., physical layer, layer-2, RRC and NAS functionality to connect to the gNB-DU of another IAB-node or the IAB-donor, to connect to the gNB-CU on the IAB-donor, and to the core network. MT is an acronym for mobile termination.

The IAB-node can access the network using either SA-mode or EN-DC. In EN-DC, the IAB-node can also connect via E-UTRA to a Master eNB (MeNB), and the IAB-donor terminates X2-C as secondary gNB (SgNB).

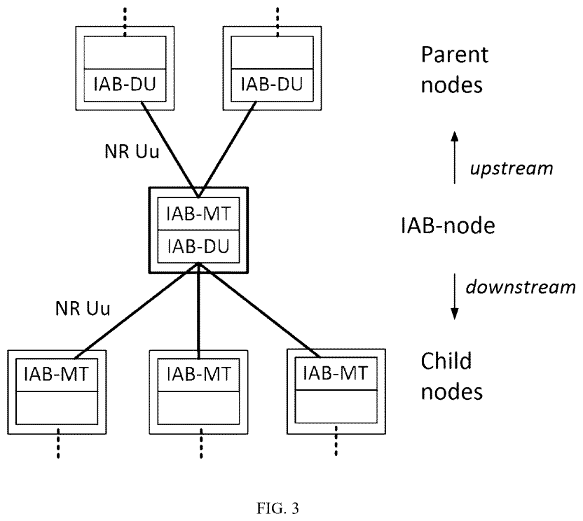

FIG. 3 shows parent-node and child-node relationship for an IAB-node. All IAB-nodes that are connected to an IAB-donor via one or multiple hops can form a directed acyclic graph (DAG) topology with the IAB-donor at its root as shown in FIG. 3. In this DAG topology, the neighbor node on the IAB-DU's interface can be referred to as child node and the neighbor node on the IAB-MT's interface can be referred to as parent node. The direction toward the child node can be further referred to as downstream while the direction toward the parent node can be referred to as upstream. The IAB-donor performs centralized resource, topology and route management for the IAB topology.

The following describes terms used in this patent document and their respective example descriptions:
IAB-donor can be a gNB that provides network access to UEs via a network of backhaul and access links.
IAB-donor-CU can be a gNB-CU of an IAB-donor, terminating the F1 interface towards IAB-nodes and IAB-donor-DU.
IAB-donor-DU can be the gNB-DU of an IAB-donor, hosting the IAB BAP sublayer, providing wireless backhaul to IAB-nodes.
IAB-DU can have a gNB-DU functionality supported by the IAB-node to terminate the NR access interface to UEs and next-hop IAB-nodes, and to terminate the F1 protocol to the gNB-CU functionality on the IAB-donor.
IAB-MT can have an IAB-node function that terminates the Uu interface to the parent node using the procedures and behaviors specified for UEs unless stated otherwise. IAB-MT function may correspond to an IAB-UE function.
IAB-node can be a RAN node that supports NR access links to UEs and NR backhaul links to parent nodes and child nodes. The IAB-node may not support backhauling via LTE.
Child node can be IAB-DU's and IAB-donor-DU's next hop neighbor node; the child node can also be an IAB-node.
Parent node can be IAB-MT's next hop neighbor node; the parent node can be IAB-node or IAB-donor-DU.
Upstream can describe a direction toward parent node in IAB-topology.
Downstream can describe a direction toward child node or UE in IAB-topology.

The example headings for the various sections below are used to facilitate the understanding of the disclosed subject matter and do not limit the scope of the claimed subject matter in any way. Accordingly, one or more features of one example section can be combined with one or more features of another example section. Furthermore, 5G terminology is used for the sake of clarity of explanation, but the techniques disclosed in the present document are not limited to 5G technology only, and may be used in wireless systems that implemented other protocols.

### I. Example Techniques for Performing Migration of a Mobile IAB Node

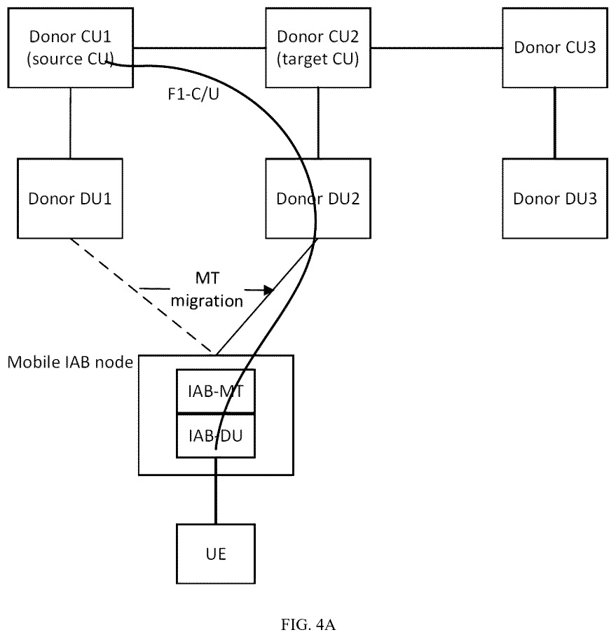

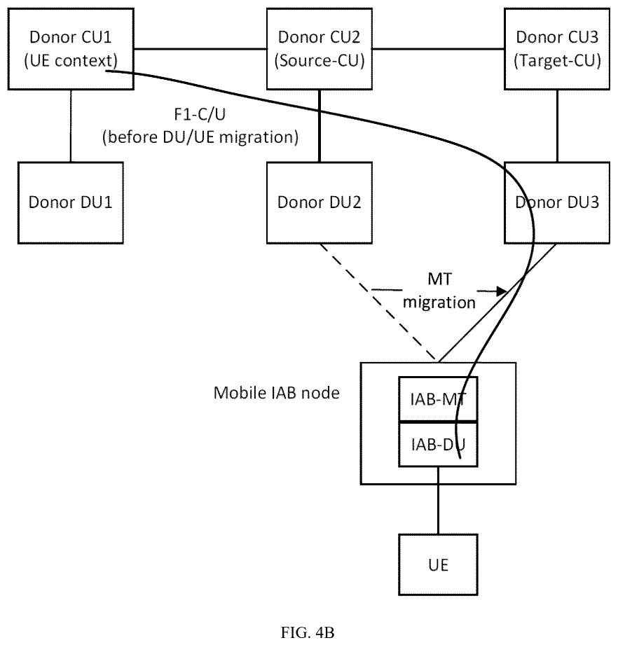

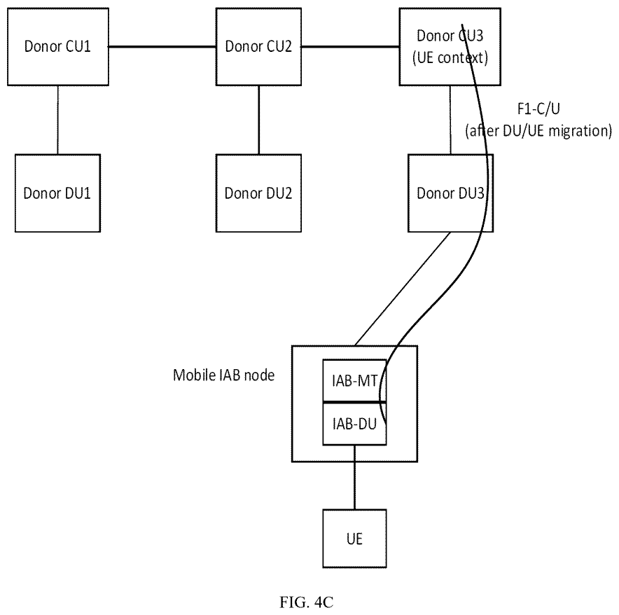

FIGS. 4A-4C show example scenarios of the inter-donor mobility of the mobile IAB node. In FIG. 4A, mobile IAB-MT migrates from donor DU1 which belongs to donor CUI to donor DU2 which belongs to donor CU2. However, the mobile IAB-DU may maintain its F1 connection with donor CUI and UE context remains in donor CU1. As shown in FIG. 4A, F1-C/U traffic between donor CUI and mobile IAB-DU is transmitted via donor DU2.

In FIG. 4B, mobile IAB-MT migrates from donor DU2 which belongs to donor CU2 to donor DU3 which belongs to donor CU3. However, the mobile IAB-DU may maintain its F1 connection with donor CUI and UE context remains in donor CU1. As shown in FIG. 4B, F1-C/U traffic between donor CUI and mobile IAB-DU is transmitted via donor DU3.

In FIG. 4C, the mobile IAB-DU migrates from donor CUI to donor CU3. And the UE is handed over from donor CU1 to donor CU3. As shown in FIG. 4C, F1-C/U traffic between donor CU3 and mobile IAB-DU can be transmitted via donor DU3.

In this patent document, the F1-terminating donor can include a CU that has F1-C connection with the mobile IAB node, e.g., the CU that serves the mobile IAB-DU.

### I. (a) Embodiment 1

There are multiple migration types for mobile IAB node inter-donor migration of mobile IAB node. However, current technology does not describe techniques to determine the migration type and to inform the migration type to the corresponding node. The techniques described in this section of patent document address at least these drawbacks of current technology. In this embodiment, the source donor can be a source CU donor that is connected to the mobile IAB MT before the handover, and the target donor is a target CU donor to which the mobile IAB MT will be connected after the handover is performed.

Step 1: optionally, during the inter-donor migration procedure of mobile IAB node (including partial migration or full migration), if the source donor of the IAB-MT and the F1-terminating donor are different donors, the source donor sends MT handover information to the F1-terminating donor, e.g., after receiving measurement report from the IAB-MT, or after receiving handover request ack message from the target donor of the IAB-MT. The MT handover information includes at least one of the following: MT handover indication, target cell ID, candidate cell ID or candidate cell ID, MT ID allocated by the source donor, MT ID allocated by the target donor (e.g., XnAP ID or BAP address).

Alternatively, the target donor of IAB-MT sends MT handover information to the F1-terminating donor, e.g., after receiving handover request message from the source donor.

Alternatively, the IAB node sends MT handover information to the F1-terminating donor, e.g., after receiving RRCreconfiguration message from the source donor.

Step 2: Optionally, if the source donor of the IAB-MT and the F1-terminating donor are different donors, F1 terminating donor can determine (e.g., based on whether there is Xn interface or IP connectivity between F1 terminating donor and the target donor) the migration type. And then F1 terminating donor can send the migration type information to the source donor or the target donor. The F1 terminating donor can have a connection with a mobile IAB DU. The migration type information can indicate whether a UE handover is to be performed and/or a sequence of handover involving the UE, mobile IAB node, DU in mobile IAB node, and/or MT in mobile IAB node. The migration type information includes at least one of the following: partial migration, full migration, UE migration first, MT migration first, DU migration first, DU migration is executed after MT migration, UE migration is executed after MT migration, DU migration is executed before MT migration, UE migration is executed before MT migration. The indication related to “UE migration first,” or “MT migration first,” or “DU migration first” can indicate that a handover is respectively first performed by UE, or MT, or DU. The indication related to “DU migration is executed after MT migration,” “UE migration is executed after MT migration,” “DU migration is executed before MT migration,” “UE migration is executed before MT migration” respectively indicate that a handover is first performed by MT and then DU, that a handover is first performed by the MT and then UE, that the handover is first performed by DU and then MT, and the handover is first performed by UE and then MT.

In some embodiments, if the F1 terminating donor determines that there is Xn and F1 connectivity between F1 terminating donor and the target donor, then the F1 terminating donor determines that partial migration could be performed and the F1 terminating donor can indicate partial migration in the migration type information. In an example implementation, a partial migration may include performing a migration of an IAB-MT to a parent node underneath a different IAB-donor-CU while the donor CU serving co-located IAB-DU and served UEs remain unchanged. In some embodiments, if the F1 terminating donor determines that there is no Xn interface between F1 terminating donor and the target donor, then the F1 terminating donor determines that full migration needs to be executed instead of partial migration and the F1 terminating donor can indicate full migration in the migration type information. In an example implementation, a full migration may include migrating the IAB-MT, co-located IAB-DU and the served UE (e.g., both RRC and F1 connection) to a target IAB-donor-CU. In some embodiments, if the F1 terminating donor determines that there is no IP connectivity between F1 terminating donor and the target donor, then the F1 terminating donor determines that DU migration needs to be executed before MT migration and the F1 terminating donor can indicate “DU migration is executed after MT migration” in the migration type information.

Step 3: The source donor of the IAB-MT sends the migration type information to the target donor of the IAB-MT, e.g., after the receiving the migration type information from the F1-terminating donor. The source donor could send the migration type information to the target donor via XnAP message, e.g., handover request message.

Step 4: The target donor includes the migration type information in the RRCreconfiguration message, and includes the RRCreconfiguration message in XnAP message. And then the target donor sends the XnAP message including the migration type information to the source donor.

Step 5: the source donor sends the RRCreconfiguration message including the migration type information to the IAB-MT.

### I. (b) Embodiment 2

Technical Problem: In normal UE handover procedure, UE context setup and release procedure is used at target and source DU respectively to setup UE context at the target DU and release UE context at the source DU. In mobile IAB scenario, the source and target DUs of the UE handover procedure are two logical DUs which co-locates in the same mobile IAB node. So it's not efficient to use UE context setup and release procedure during UE handover procedure. One potential solution is that UE context may be shared between the two logical DUs in the mobile IAB-node. In this way, UE context modification could be used to update UE context at the mobile IAB node, instead of UE context setup/release procedure at source/target logical DU respectively. The technical problem is how to transfer UE information used in the target logical DU (e.g., the logical DU that has F1 connection with the target donor) to the target donor if UE context setup procedure is not used during UE handover procedure.

In the Example Solution presented below, the mobile IAB node is handover from a source DU to a target DU, where a UE is connected to a source logical DU in mobile IAB node before the handover, and the UE is connected to a target logical DU in the mobile IAB node after the handover.

Example Solution: UE information is sent from the target logical DU in the mobile IAB node to the target donor (e.g., target donor CU), e.g., via F1AP UE context modification response or IAB UP configuration update response message. The UE information includes at least one of the following: the cell radio network temporary identifier (C-RNTI) allocated by the mobile IAB node for the UE, the old C-RNTI allocated by the source logical DU for the UE, the new C-RNTI allocated by the target logical DU for the UE. The C-RNTI allocated by the mobile IAB node may not be changed and can be used to identify the UE in source logical DU and target logical DU. The old C-RNTI is used to identify the UE in the source logical DU, and the new C-RNTI is used to identify the UE by the target logical DU.

### I. (c) Embodiment 3

Technical Problem: If DU migration is executed before MT migration in an IAB node, target logical DU in the IAB node needs to setup F1 connection with the target donor before MT migration. So F1 traffic between the target donor and the mobile IAB node needs to be transferred via the source path, e.g., through the source parent DU and the source donor DU. The problem is how to transfer F1 traffic between target CU and the mobile IAB node via source path.

In the example solution presented below, a migration of the mobile IAB node is facilitated from a source donor CU to a target donor CU, where the migration of the DU in IAB node is executed before the migration of the MT in the same IAB node.

### Example Solution

Step 1: F1 terminating donor or source donor of IAB-MT sends DSCP/Flow label to be used for downlink F1 traffic to target donor of IAB-MT. The target donor can set the DSCP/Flow label of F1 traffic according to the DSCP/Flow label information received from the F1 terminating donor or source donor.

Step 2: target donor obtain new DL TNL address used by the mobile IAB node via F1AP, e.g., F1 setup, DU configuration update, or IAB UP configuration update response message.

Step 3: the target donor sends new DL TNL address for F1 traffic to source donor via XnAP message to the source donor. The source donor can use the new DL TNL address for DL mapping configuration at the source donor DU.

Alternatively, the target donor sends the new DL TNL address for F1 traffic to the F1-terminating donor via XnAP message. And then the F1-terminating donor sends the new DL TNL address to the source donor via XnAP message.

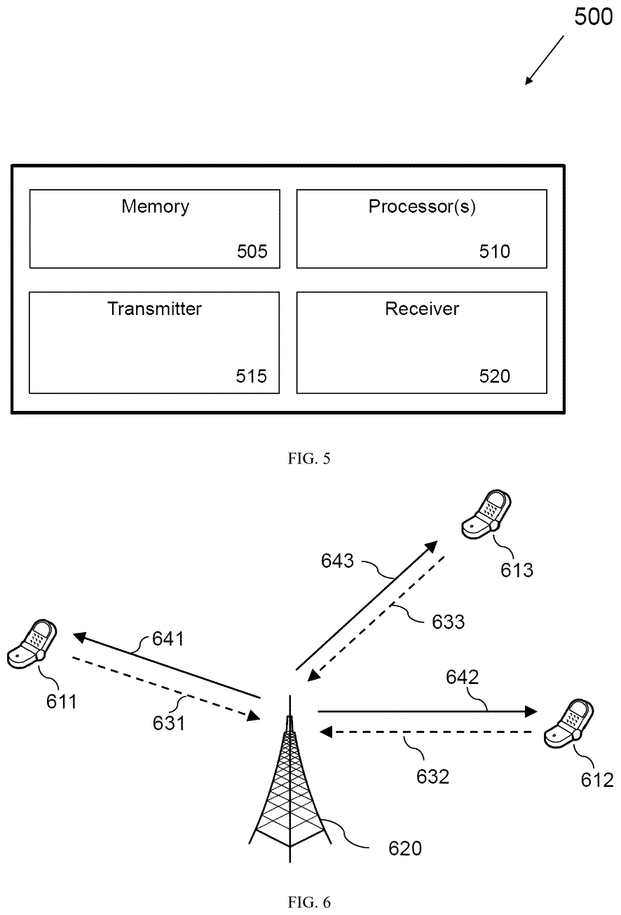

FIG. 5 shows an exemplary block diagram of a hardware platform 500 that may be a part of a network device (e.g., base station) or a communication device (e.g., a user equipment (UE)). The hardware platform 500 includes at least one processor 510 and a memory 505 having instructions stored thereupon. The instructions upon execution by the processor 510 configure the hardware platform 500 to perform the operations described in FIGS. 1 to 4C and 6 to 9 and in the various embodiments described in this patent document. The transmitter 515 transmits or sends information or data to another device. For example, a network device transmitter can send a message to a user equipment. The receiver 520 receives information or data transmitted or sent by another device. For example, a user equipment can receive a message from a network device.

The implementations as discussed above will apply to a wireless communication. FIG. 6 shows an example of a wireless communication system (e.g., a 5G or NR cellular network) that includes a base station 620 and one or more user equipment (UE) 611, 612 and 613. In some embodiments, the UEs access the BS (e.g., the network) using a communication link to the network (sometimes called uplink direction, as depicted by dashed arrows 631, 632, 633), which then enables subsequent communication (e.g., shown in the direction from the network to the UEs, sometimes called downlink direction, shown by arrows 641, 642, 643) from the BS to the UEs. In some embodiments, the BS send information to the UEs (sometimes called downlink direction, as depicted by arrows 641, 642, 643), which then enables subsequent communication (e.g., shown in the direction from the UEs to the BS, sometimes called uplink direction, shown by dashed arrows 631, 632, 633) from the UEs to the BS. The UE may be, for example, a smartphone, a tablet, a mobile computer, a machine to machine (M2M) device, an Internet of Things (IoT) device, and so on.

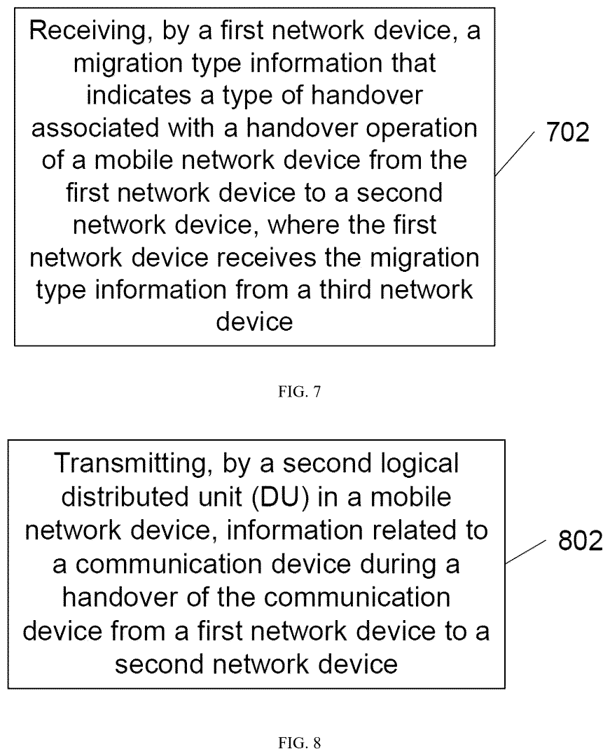

FIG. 7 shows an exemplary flowchart for receiving a migration type information. Operation 702 includes receiving, by a first network device, a migration type information that indicates a type of handover associated with a handover operation of a mobile network device from the first network device to a second network device, where the first network device receives the migration type information from a third network device. In some embodiments, the method further comprises sending a first message comprising the migration type information to the second network device. In some embodiments, the method further comprises receiving a second message comprising the migration type information from the second network device; and transmitting, by the first network device and in response to the receiving the second message, the migration type information to the mobile network device.

In some embodiments, the type of handover indicates a sequence of operations associated with the handover operation for the mobile network device and/or a communication device in communication with the mobile network device. In some embodiments, the migration type information includes any one or more of: a partial migration, a full migration, a user equipment (UE) migration first that indicates that the handover operation is performed for the communication device before the handover operation for the mobile network device, a mobile termination (MT) migration first that indicates that the handover operation is first performed for the MT in the mobile network device, a distributed unit (DU) migration first that indicates that the handover operation is first performed for the DU in the mobile network device, a DU migration is executed after MT migration that indicates that the handover operation is performed for the DU in the mobile network device after the handover operation is performed for the MT in the mobile network device, a UE migration is executed after MT migration that indicates that the handover operation is performed for the communication device after the handover operation is performed for the MT in the mobile network device, a DU migration is executed before MT migration that indicates that the handover operation is performed for the DU in the mobile network device before the handover operation is performed for the MT in the mobile network device, or a UE migration is executed before MT migration that indicates that the handover operation is performed for the communication device before the handover operation is performed for the MT in the mobile network device.

In some embodiments, the first network device includes a first Integrated Access and Backhaul (IAB) donor to which the mobile network device is connected before the handover, where the second network device includes a second IAB donor to which the mobile network device will be connected after the handover, and/or where the third network device includes a third IAB donor that has a connection with the mobile network device. In some embodiments, the mobile network device includes a mobile Integrated Access and Backhaul (IAB) device.

FIG. 8 shows an exemplary flowchart for transmitting information related to a communication device. Operation 802 includes transmitting, by a second logical distributed unit (DU) in a mobile network device, information related to a communication device during a handover of the communication device from a first network device to a second network device, where the second logical DU in the mobile network device transmits the information related to the UE to the second network device, where the communication device is in communication with the mobile network device, where the second logical DU is configured to communicate with the second network device, and where the information related to the communication device includes any one or more of: a cell radio network temporary identifier (C-RNTI) allocated by the mobile network device for the communication device, a first C-RNTI allocated by a first logical DU in the mobile network device for the communication device, a second C-RNTI allocated by the second logical DU in the mobile network device for the communication device. In some embodiments, the first network device includes a source base station, and the second network device includes a target base station. In some embodiments, the mobile network device includes an Integrated Access and Backhaul (IAB) device.

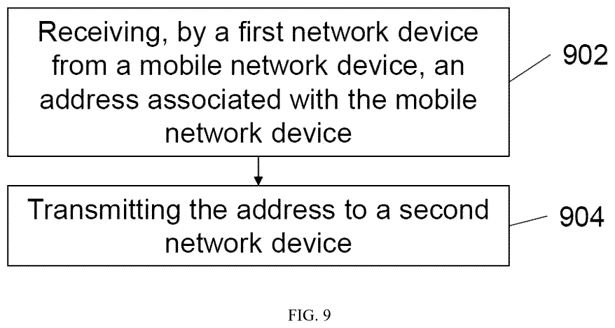

FIG. 9 shows an exemplary flowchart for receiving an address associated with a mobile network device. Operation 902 includes receiving, by a first network device from a mobile network device, an address associated with the mobile network device. Operation 904 includes transmitting the address to a second network device. In some embodiments, the address includes a downlink (DL) transport network layer (TNL) address for F1 traffic which goes through a donor DU which connects to the second network device. In some embodiments, the first network device includes a target base station to which a mobile termination (MT) in the mobile network device is handed over, and the second network device includes a source base station from which the MT in the mobile network device is handed over. In some embodiments, the mobile network device includes an Integrated Access and Backhaul (IAB) device.

In this document the term “exemplary” is used to mean “an example of” and, unless otherwise stated, does not imply an ideal or a preferred embodiment.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer-or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination.

Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure

1. A wireless communication method, comprising:
receiving, by a first network device, a migration type information that indicates a type of handover associated with a handover operation of a mobile network device from the first network device to a second network device,
wherein the first network device receives the migration type information from a third network device.

2. The method of claim 1, further comprising:
sending a first message comprising the migration type information to the second network device.

3. The method of claim 1, further comprising:
receiving a second message comprising the migration type information from the second network device; and
transmitting, by the first network device and in response to the receiving the second message, the migration type information to the mobile network device.

4. The method of claim 1, wherein the type of handover indicates a sequence of operations associated with the handover operation for the mobile network device and/or a communication device in communication with the mobile network device.

5. The method of claim 1, wherein the migration type information includes any one or more of:
a partial migration,
a full migration,
a user equipment (UE) migration first that indicates that the handover operation is performed for the communication device before the handover operation for the mobile network device,
a mobile termination (MT) migration first that indicates that the handover operation is first performed for the MT in the mobile network device,
a distributed unit (DU) migration first that indicates that the handover operation is first performed for the DU in the mobile network device,
a DU migration is executed after MT migration that indicates that the handover operation is performed for the DU in the mobile network device after the handover operation is performed for the MT in the mobile network device,
a UE migration is executed after MT migration that indicates that the handover operation is performed for the communication device after the handover operation is performed for the MT in the mobile network device,
a DU migration is executed before MT migration that indicates that the handover operation is performed for the DU in the mobile network device before the handover operation is performed for the MT in the mobile network device, or
a UE migration is executed before MT migration that indicates that the handover operation is performed for the communication device before the handover operation is performed for the MT in the mobile network device.

6. The method of claim 1,
wherein the first network device includes a first Integrated Access and Backhaul (IAB) donor to which the mobile network device is connected before the handover,
wherein the second network device includes a second IAB donor to which the mobile network device will be connected after the handover, or
wherein the third network device includes a third IAB donor that has a connection with the mobile network device.

7. The method of claim 1, wherein the mobile network device includes a mobile Integrated Access and Backhaul (IAB) device.

8. A wireless communication method, comprising:
transmitting, by a second logical distributed unit (DU) in a mobile network device, information related to a communication device during a handover of the communication device from a first network device to a second network device,
wherein the second logical DU in the mobile network device transmits the information related to the UE to the second network device,
wherein the communication device is in communication with the mobile network device,
wherein the second logical DU is configured to communicate with the second network device, and
wherein the information related to the communication device includes any one or more of:
a cell radio network temporary identifier (C-RNTI) allocated by the mobile network device for the communication device,
a first C-RNTI allocated by a first logical DU in the mobile network device for the communication device,
a second C-RNTI allocated by the second logical DU in the mobile network device for the communication device.

9. The method of claim 8, wherein the first network device includes a source base station, and wherein the second network device includes a target base station.

10. The method of claim 8, wherein the mobile network device includes an Integrated Access and Backhaul (IAB) device.

11. A wireless communication method, comprising:
receiving, by a first network device from a mobile network device, an address associated with the mobile network device; and
transmitting the address to a second network device.

12. The method of claim 11, wherein the address includes a downlink (DL) transport network layer (TNL) address for F1 traffic which goes through a donor DU which connects to the second network device.

13. The method of claim 11,
wherein the first network device includes a target base station to which a mobile termination (MT) in the mobile network device is handed over, and
wherein the second network device includes a source base station from which the MT in the mobile network device is handed over.

14. The method of claim 11, wherein the mobile network device includes an Integrated Access and Backhaul (IAB) device.

15. An apparatus for wireless communication comprising a processor, configured to implement a method according to claim 1.

16. A non-transitory computer readable program storage medium having code stored thereon, the code, when executed by a processor, causing the processor to implement a method according to claim 1.

17. A non-transitory computer readable program storage medium having code stored thereon, the code, when executed by a processor, causing the processor to implement a method according to claim 8.

18. A non-transitory computer readable program storage medium having code stored thereon, the code, when executed by a processor, causing the processor to implement a method according to claim 11.

19. An apparatus for wireless communication comprising a processor, configured to implement a method according to claim 8.

20. An apparatus for wireless communication comprising a processor. configured to implement a method according to claim 11
